(19) United States
(12) Patent Application Publication
(10) Pub. No.: US 2011/0142346 A1
(43) Pub. Date: Jun. 16, 2011

(54) APPARATUS AND METHOD FOR BLOCKING OBJECTIONABLE MULTIMEDIA BASED ON SKIN COLOR AND FACE INFORMATION

(75) Inventors: Seung Wan HAN, Gwangju (KR); Jae Deok LIM, Daejeon (KR); Byeong Cheol CHOI, Daejeon (KR); Byung Ho CHUNG, Daejeon (KR)

(73) Assignee: Electronics and Telecommunications Research Institute, Daejeon (KR)

(21) Appl. No.: 12/965,310

(22) Filed: Dec. 10, 2010

(30) Foreign Application Priority Data
Dec. 11, 2009 (KR) 10-2009-0123422

(51) Int. Cl. G06K 9/46

(52) U.S. Cl. 382/190

(57) ABSTRACT

Provided are an apparatus and method for blocking objectionable multimedia based on skin color and face information. The apparatus for blocking objectionable multimedia can block objectionable multimedia by obtaining skin color and face information from multimedia learning data and analyzing it to generate features that may express the objectionability, for example, the presence of a person, a body shape, and the degree of nudity; generating objectionability classification model through statistical analysis and machine learning on the features; and determining the objectionability of newly input multimedia based on the objectionability classification model.

### CROSS-REFERENCE TO RELATED APPLICATION

This application claims priority to and the benefit of Korean Patent Application No. 10-2009-0123422, filed Dec. 11, 2009, the disclosure of which is incorporated herein by reference in its entirety.

### BACKGROUND

1. Field of the Invention

The present invention relates to an apparatus and method for blocking objectionable obscene multimedia such as a kiss scene or a naked scene by using skin color and face information included in a multimedia image, and more particularly, to an apparatus and method for blocking objectionable obscene multimedia by generating an objectionability classification model using objectionable multimedia features based on skin color and face information generated from multimedia learning data and determining the objectionability of newly input multimedia using the objectionability classification model.

2. Discussion of Related Art

The Internet has a sufficient variety of information to be called a sea of information. The Internet is convenient to use and has become a part of everyday life of many people living in the present day. The Internet provides positive effects in social, economical, and scholastic point of views, but thoughtless distribution of objectionable information misusing openness, interconnectivity, and anonymity of the Internet has become a serious social problem. Particularly, young people who can connect to the Internet at any time are exposed to objectionable information more frequently than before. Such an Internet environment can seduce and emotionally and mentally harm young people who have low value judgment and weak self control. For these reasons, there is a need for a technique of blocking objectionable information so that socially weak people such as young people or people who do not want to be are not exposed to objectionable information.

Examples of a conventional technique of blocking objectionable multimedia include a metadata/text information based blocking technique, a hash/database based blocking technique, and a content-based blocking technique. The metadata/text information based blocking technique judges whether or not multimedia is objectionable by analyzing objectionability of a multimedia title, a file name, and text included in a description. The metadata/text information based blocking technique is high in an over-blocking rate and an erroneous blocking rate. The hash/database based blocking technique judges objectionability of multimedia by computing hash values of previously known objectionable multimedia to build a database, computing a hash value of newly input multimedia, and comparing the hash value of the newly input multimedia with the those in the database to thereby determine the objectionability of newly input multimedia. In this technique, as objectionable multimedia increases, the size of a hash value database increases, and computation cost for determining objectionability of multimedia increases. Further, if a hash value of previously known multimedia changes through slight modification, multimedia is not blocked.

The recently suggested content-based blocking technique analyzes contents of objectionable multimedia to generate features, generates an objectionability classification model using the feature, and judges objectionability of input multimedia based on the objectionability classification model. This technique can resolve the problems of the high over-blocking rate and the high erroneous blocking rate occurring in the metadata/text information based blocking technique and the problems of the large database size and the high computation cost occurring in the hash/database based blocking technique.

However, in most of the content-based blocking techniques, low level features such as a color, a texture, and a shape are used as features of objectionable multimedia, or an MPEG-7 descriptor mainly used in multimedia search is usually used. However, such information does not properly reflect features of objectionable multimedia and therefore shows a low blocking rate and a high erroneous blocking rate. In order to solve these problems, as a recently suggested technique, a skin color is searched in units of pixels, and a ratio between a skin color and a non-skin color is used as a feature for objectionability judgment. However, this approach using such features is not sufficient to accurately describe and abbreviate actual objectionable multimedia in semantics, and thus an objectionability classification model generated by using the feature still shows low performance.

Therefore, in order to lower the over-blocking rate and the erroneous blocking rate in the objectionable multimedia blocking technique, definition of features that can more accurately describe and abbreviate objectionable multimedia in semantics and a technique of blocking objectionable multimedia based on the features are necessary.

### SUMMARY OF THE INVENTION

The present invention is directed to an apparatus and method for blocking objectionable multimedia by obtaining skin color and face information from multimedia learning data and analyzing it to generate features that may express the objectionability, for example, the presence of a person, a body shape, and the degree of nudity; generating objectionability classification model through statistical analysis and machine learning on the features; and determining the objectionability of newly input multimedia based on the objectionability classification model.

One aspect of the present invention provides an apparatus for blocking objectionable multimedia based on skin color and face information that includes a learning data feature producing unit that detects skin color and face data from multimedia learning data and analyzes the skin color and face data to produce skin color/face based objectionable/unobjectionable features; a classification model producing unit that produces an objectionability classification mode through a statistical process and machine learning on the skin color/face based objectionable/unobjectionable features; an input data feature producing unit that detects skin color and face data from multimedia data input for objectionability judgment and analyzes the skin color and face data to produce skin color/face based features of the input multimedia; a multimedia objectionability judging unit that compares the skin color/face based features of the input multimedia with the objectionability classification model to determine whether or not the input multimedia is objectionable, and an objectionable multimedia blocking unit that blocks the input multimedia when it is determined as objectionable.

Another aspect of the present invention provides a method of blocking objectionable multimedia based on skin color and face information that includes detecting skin color and face data from multimedia learning data and analyzing the skin color and face data to produce skin color/face based objectionable/unobjectionable features; producing an objectionability classification mode from the skin color/face based objectionable/unobjectionable features; detecting skin color and face data from multimedia data input for objectionability judgment and analyzing the skin color and face data to produce skin color/face based features of the input multimedia; comparing the skin color/face based features of the input multimedia with the objectionability classification model to determine whether or not the input multimedia is objectionable; and blocking the input multimedia when it is determined as objectionable.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a functional block diagram illustrating a structure of an apparatus for blocking objectionable multimedia based on skin color and face information according to an exemplary embodiment of the present invention;

FIG. 2 is a block diagram illustrating a detailed structure of the apparatus for blocking objectionable multimedia illustrated in FIG. 1; and

FIG. 3 is a flowchart illustrating a method of blocking objectionable multimedia based on skin color and face information according to an exemplary embodiment of the present invention.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. Therefore, the following embodiments are described in order for this disclosure to be complete and enabling to those of ordinary skill in the art. To clearly describe the present invention, parts not relating to the description are omitted from the drawings. Like numerals refer to like elements throughout the description of the drawings.

Throughout this specification, when an element is referred to as “comprises,” “includes,” or “has” a component, it does not preclude another component but may further include the other component unless the context clearly indicates otherwise. Also, as used herein, the terms “ . . . unit,” “ . . . module,” etc., denote a unit of processing at least one function or operation, and may be implemented as hardware, software, or combination of hardware and software.

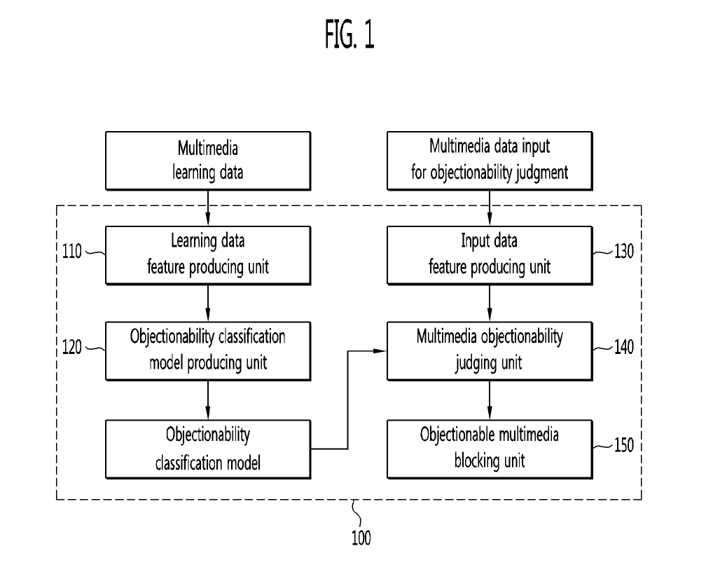

FIG. 1 is a functional block diagram illustrating a structure of an apparatus for blocking objectionable multimedia based on skin color and face information according to an exemplary embodiment of the present invention.

Referring to FIG. 1, the apparatus for blocking objectionable multimedia includes a learning data feature producing unit 110, an objectionability classification model producing unit 120, an input data feature producing unit 130, a multimedia objectionability judging unit 140, and an objectionable multimedia blocking unit 150. These units can be software and/or hardware modules that may reside on a computing device 100. The computing device 100 typically includes at least one processing unit (not shown) and system memory (not shown).

The learning data feature producing unit 110 detects skin color and face data from multimedia learning data whose objectionability or unobjectionability was previously known and analyzes them to produce objectionable/unobjectionable multimedia features that are based on skin color and face information.

The objectionability classification model producing unit 120 builds an objectionability classification model by performing a statistical process and machine learning process on the objectionable/unobjectionable features produced by the skin color/face based objectionable feature producing unit 110. The objectionability classification model will be used as a reference model for determining whether or not a target multimedia is objectionable later.

The input data feature producing unit 130 detects skin color and face data from target multimedia data, which are input for objectionability judgment, and analyzes them to produce skin color/face based features of them.

The multimedia objectionability judging unit 140 determines objectionability of multimedia by comparing the features of the target multimedia produced by the input data feature producing unit 130 with the objectionability classification model produced by the objectionability classification model producing unit 120.

The objectionable multimedia blocking unit 150 blocks the target multimedia when it is determined as objectionable by the multimedia objectionability judging unit 140.

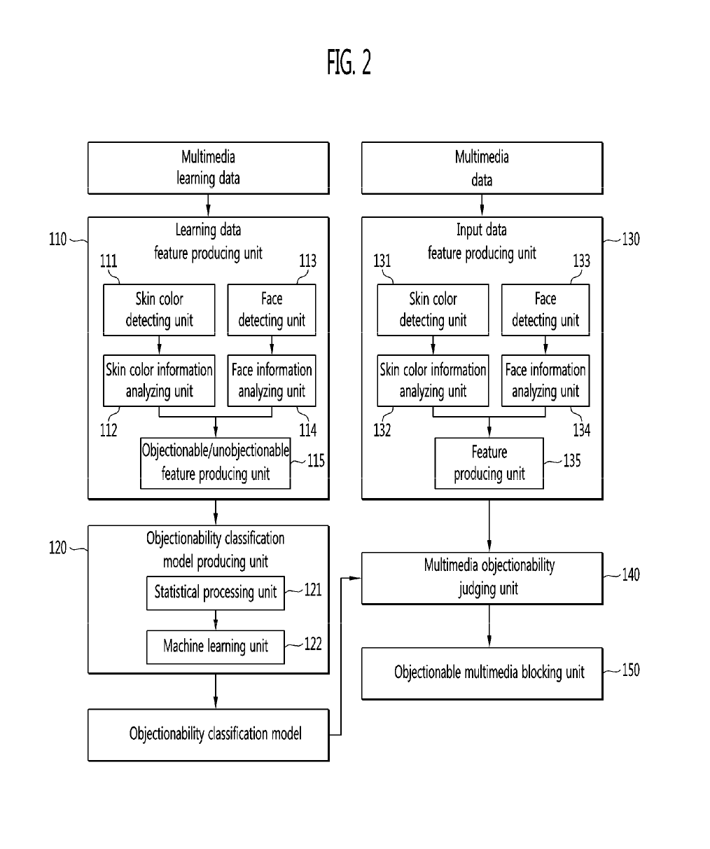

FIG. 2 is a block diagram illustrating a detailed structure of the apparatus for blocking objectionable multimedia illustrated in FIG. 1. As illustrated in FIG. 2, the learning data feature producing unit 110 includes a skin color detecting unit 111 that detects skin color data from multimedia learning data; a skin color information analyzing unit 112 that analyzes the detected skin color data to produce skin color information such as a skin color ratio, the number of skin color areas, and the position, distribution, size, and shape of the skin color area; a face detecting unit 113 that detects face data from multimedia learning data; a face information analyzing unit 114 that produces face information such as the number of faces, and the position, direction, and shape of the face from the detected face data; and an objectionable/unobjectionable feature producing unit 115 that produces representative objectionable/unobjectionable multimedia features using the skin color information produced by the skin color information analyzing unit 112 and the face information generated by the face information analyzing unit 114.

The objectionability classification model producing unit 120 includes a statistical processing unit 121 and a machine learning unit 122 and produces the objectionability classification model through a statistical process and machine learning on the objectionable/unobjectionable features produced by the learning data feature producing unit 110. The statistical processing unit 121 establishes a statistical model including trend analysis and a boundary value setting on the objectionable features and performs machine learning on the statistical model result and the objectionable features to produce the objectionability classification model. The objectionability classification model is used to judge objectionability of multimedia through the multimedia objectionability judging unit 140 later.

The input data feature producing unit 130 includes a skin color detecting unit 131, a skin color information analyzing unit 132, a face detecting unit 133, a face information analyzing unit 134, and a feature producing unit 135, similarly to the learning data feature producing unit 110. The input data feature producing unit 130 produces skin color and face—based features of target multimedia data input for the sake of objectionability judgment. In further detail, the input data feature producing unit 130 includes the skin color detecting unit 131 that detects skin color data from the target multimedia data; the skin color information analyzing unit 132 that analyzes the detected skin color data to produce skin color information such as a skin color ratio, and the number of skin color areas, and the position, distribution, size, and shape of the skin color area; the face detecting unit 133 that detects face data from the target multimedia data; the face information analyzing unit 134 that produces face information such as the number of faces, and the position, direction, and shape of the face from the detected face data; and the feature producing unit 135 that produces features of the target multimedia using the skin color information produced by the skin color information analyzing unit 132 and the face information generated by the face information analyzing unit 134.

The multimedia objectionability judging unit 140 compares the features of the target multimedia produced by the input data feature producing unit 130 with the objectionability classification model to determine whether or not the target multimedia is objectionable. The objectionable multimedia blocking unit 140 blocks the target multimedia when it is determined as objectionable.

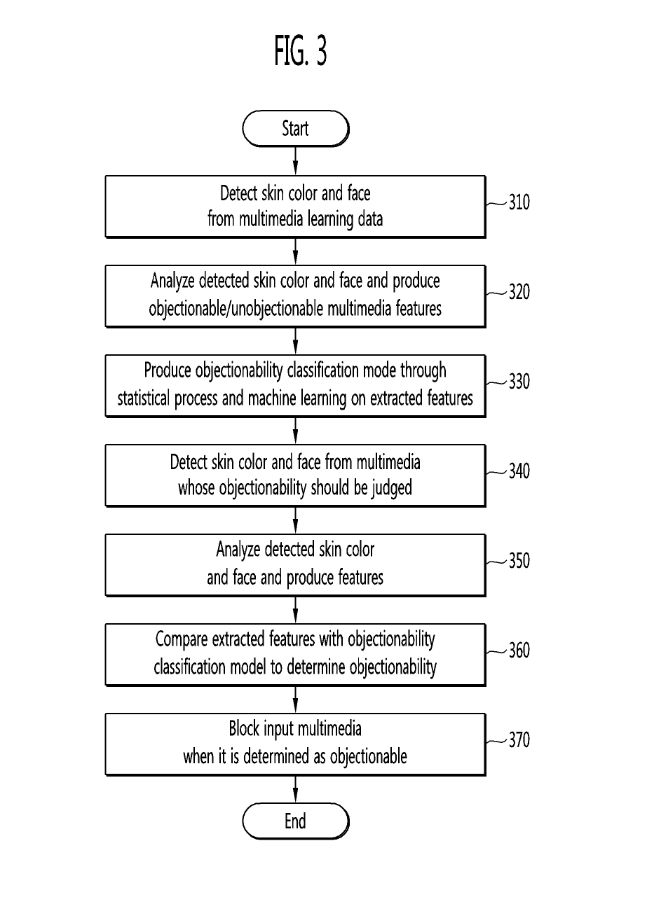

FIG. 3 is a flowchart illustrating a method of blocking objectionable multimedia based on skin color and face information according to an exemplary embodiment of the present invention. Referring to FIG. 3, skin color and face data are detected from multimedia learning data, in which the degree of objectionability and unobjectionability was previously known (S310). The skin color and face data may be detected by using a widely known conventional technique or a detection model in which features of objectionable multimedia are newly reflected.

The skin color and face data detected in step S310 are analyzed to produce objectionable/unobjectionable multimedia features (S320). The features produced through analysis of the skin color and face data may include skin color information such as a skin color ratio, and the number of skin color areas, and the position, distribution, size, and shape of the skin color area and face information such as the number of faces, and the position, direction, and shape of the face.

The objectionable/unobjectionable features are subjected to the statistical process and machine learning to produce the objectionability classification model (step S330).

Skin color and face data are detected from target multimedia data input for objectionability judgment (step S340).

The skin color and face data detected in step S340 are analyzed to produce multimedia features (step S350). The features produced through analysis of the skin color and face data may include skin color information such as a skin color ratio, and the number of skin color areas, the position, distribution, size, and shape of the skin color area and face information such as the number of faces, the position, direction, and shape of the face.

The features produced in step S350 are compared with the objectionability classification model to determine whether or not the target multimedia is objectionable (S360).

Finally, when it is determined that the target multimedia is objectionable, it is blocked (S370).

As described above, according to the present invention, using characteristics of an image including a person whose body is partially nude, the presence of a person, the degree of nudity, a body posture, and a behavior between persons are analyzed from objectionable multimedia based on skin color and face information to thereby produce objectionable features. An objectionability classification model is produced based on the objectionable features. The objectionability classification model is used to determine objectionability of multimedia input for objectionability judgment later. Since the objectionable features based on the skin color and the face information are used, an over-blocking rate and an erroneous blocking rate occurring when blocking objectionable multimedia can be significantly reduced.

As described above, according to an apparatus and method for blocking multimedia based on skin color and face information of the present invention, an objectionability classification model is produced through statistical analysis and machine learning of features (skin color information such as a skin color ratio, and the number of skin color areas, and the position, distribution, size, and shape of the skin color area and face information such as the number of faces, and the position, direction, and shape of the face) that are obtained by detecting and analyzing skin color and face information included in a multimedia image, and it is determined whether or not the multimedia is objectionable by using the objectionability classification model. An over-blocking rate and an erroneous blocking rate occurring when blocking objectionable multimedia can be reduced. Further, an apparatus and method for blocking multimedia based on skin color and face information according to the present invention use skin color information and face information such as the number of faces, and the position, direction, and shape of the face included in an image. Therefore, semantics based analysis of multimedia is possible, and multimedia can be classified according to the degree of objectionability.

The present invention may be implemented as a computer readable code stored in a computer readable record medium. Examples of the computer readable record medium include a ROM, a RAM, a CD_ROM, a magnetic tape, a floppy disk, and an optical data storage device. The present invention may be implemented in the form of a carrier wave (for example, transmission through the Internet). The computer readable record medium may be distributed to a computer system connected through a network, stored in the form of a computer readable code, and executed.

Further, an apparatus and method for blocking multimedia based on skin color and face information according to the present invention can be employed in portable multimedia reproducing devices such as an MP3, a PMP, a cellular phone, and a PDA.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An apparatus for blocking objectionable multimedia based on skin color and face information, the apparatus comprising:
a learning data feature producing unit that detects skin color and face data from multimedia learning data and analyzes the skin color and face data to produce skin color/face based objectionable/unobjectionable features;
a classification model producing unit that produces an objectionability classification mode through a statistical process and machine learning on the skin color/face based objectionable/unobjectionable features;
an input data feature producing unit that detects skin color and face data from multimedia data input for objectionability judgment and analyzes the skin color and face data to produce skin color/face based features of the input multimedia;
a multimedia objectionability judging unit that compares the skin color/face based features of the input multimedia with the objectionability classification model to determine whether or not the input multimedia is objectionable; and
an objectionable multimedia blocking unit that blocks the input multimedia when it is determined as objectionable.

2. The apparatus according to claim 1, wherein the multimedia learning data is data in which objectionability or unobjectionability was previously known.

3. The apparatus according to claim 1, wherein the learning data feature producing unit comprises:
a skin color detecting unit that detects skin color data from the multimedia learning data;
a face detecting unit that detects face data from the multimedia learning data;
a skin color information analyzing unit that analyzes the detected skin color data to produce skin color information including at least one of a skin color ratio, the number of skin color areas, the position, distribution, size, and shape of the skin color, and a correlation between the skin colors;
a face information analyzing unit that analyzes the detected face data to produce face information including at least one of the number of faces, the position, direction, and shape of the face, and a correlation between the faces; and
an objectionable/unobjectionable feature producing unit that produces skin color/face based objectionable/unobjectionable features from the skin color information and the face information.

4. The apparatus according to claim 1, wherein the objectionability classification model producing unit comprises:
a statistical processing unit that establishes a statistical model including trend analysis and boundary value setting on the skin color/face based objectionable/unobjectionable features; and
a machine learning unit that performs machine learning on the skin color/face based objectionable/unobjectionable features and the statistical model.

5. The apparatus according to claim 1, wherein the input data feature producing unit comprises:
a skin color detecting unit that detects skin color data from the input multimedia data;
a face detecting unit that detects face data from the input multimedia data;
a skin color information analyzing unit that analyzes the detected skin color data to produce skin color information including at least one of a skin color ratio, the number of skin color areas, the position, distribution, size, and shape of the skin color, and a correlation between the skin colors;
a face information analyzing unit that analyzes the detected face data to produce face information including at least one of the number of faces, the position, direction, and shape of the face, and a correlation between the faces; and
a feature producing unit that produces skin color/face based features of the input multimedia from the skin color information and the face information.

6. The apparatus according to claim 1, wherein the learning data feature producing unit and the input data feature producing unit produce the skin color/face based objectionable/unobjectionable features and the skin color/face based features, respectively, in the same way.

7. A method of blocking objectionable multimedia based on skin color and face information, the method comprising:
detecting skin color and face data from multimedia learning data and analyzing the skin color and face data to produce skin color/face based objectionable/unobjectionable features;
producing an objectionability classification mode from the skin color/face based objectionable/unobjectionable features;
detecting skin color and face data from multimedia data input for objectionability judgment and analyzing the skin color and face data to produce skin color/face based features of the input multimedia;
comparing the skin color/face based features of the input multimedia with the objectionability classification model to determine whether or not the input multimedia is objectionable; and
blocking the input multimedia when it is determined as objectionable.

8. The method according to claim 7, wherein the multimedia learning data is data in which objectionability or unobjectionability was previously known.

9. The method according to claim 7, wherein detecting the skin color and face data from multimedia learning data and analyzing the skin color and face data to produce skin color/face based objectionable/unobjectionable features comprises:
detecting skin color and face data from the multimedia learning data;
analyzing the detected skin color data to produce skin color information including at least one of a skin color ratio, the number of skin color areas, the position, distribution, size, and shape of the skin color, and a correlation between the skin colors;
analyzing the detected face data to produce face information including at least one of the number of faces, the position, direction, and shape of the face, and a correlation between the faces; and
producing skin color/face based objectionable/unobjectionable features from the skin color information and the face information.

10. The method according to claim 7, wherein producing the objectionability classification mode from the skin color/face based objectionable/unobjectionable features comprises:
establishing a statistical model including trend analysis and boundary value setting on the skin color/face based objectionable/unobjectionable features; and
performing machine learning on the skin color/face based objectionable/unobjectionable features and the statistical model.

11. The method according to claim 7, wherein detecting the skin color and face data from multimedia data input for objectionability judgment and analyzing the skin color and face data to produce skin color/face based features of the input multimedia comprises:
detecting skin color and face data from the input multimedia data;
analyzing the detected skin color data to produce skin color information including at least one of a skin color ratio, the number of skin color areas, the position, distribution, size, and shape of the skin color, and a correlation between the skin colors;
analyzing the detected face data to produce face information including at least one of the number of faces, the position, direction, and shape of the face, and a correlation between the faces; and
producing skin color/face based features of the input multimedia from the skin color information and the face information.

12. The method according to claim 7, wherein the skin color/face based objectionable/unobjectionable features and the skin color/face based features are produced in the same way.
